(19) United States
(12) Patent Application Publication
(10) Pub. No.: US 2014/0102307 A1
(43) Pub. Date: Apr. 17, 2014

(54) WATER TANK FOR A HOUSEHOLD DEVICE AND A HOUSEHOLD DEVICE

(71) Applicant: Melitta Europa GmbH & Co.KG., Minden (DE)

(72) Inventor: Andreas Sachtleben, Minden (DE)

(73) Assignee: Melitta Europa GmbH & Co.KG., Minden (DE)

(21) Appl. No.: 14/054,159

(22) Filed: Oct. 15, 2013

(30) Foreign Application Priority Data
Oct. 15, 2012 (DE) DE202012103939.7

(51) Int. Cl. A47J 31/44

(52) U.S. Cl. CPC A47J 31/4457
USPC 99/285; 73/427

(57) ABSTRACT

A water tank for a household device includes a tank container with a bottom and side walls. At least one of the side walls includes filling-level markings that comprise a profiling formed integrally with the at least one side wall.

### CROSS-REFERENCE TO RELATED APPLICATION

This application claims the priority of German Patent Application DE 20 2012 103 939.7, filed on Oct. 15, 2012, the subject matter of which is incorporated herein by reference.

### BACKGROUND OF THE INVENTION

The present invention relates to a water tank for a household device, in particular used for the beverage preparation, comprising a tank container with a bottom and side walls, wherein a filling level marking is provided on at least one side wall.

Devices used for the preparation of beverages are available which comprise a tank container provided with a filling level indicator. The tank container can be manufactured from a transparent plastic material, and the filling level indicator can then be affixed later on by printing it on or with the aid of a thermal transfer. However, the steps for affixing readable filling level markings by printing or by thermal transfer are relatively involved. In addition, a filling level indicator of this type is optically not very appealing.

### SUMMARY OF THE INVENTION

It is therefore an object of the present invention to make available a water tank provided with filling level markings which are easily produced and which are optically appealing.

The above and other objects are achieved according to the invention wherein there is provided, according to one embodiment, a water tank for a household device, including: a tank container with a bottom and side walls, wherein at least one of the side walls includes filling-level markings that comprise a profiling formed integrally with the at least one side wall.

According to the invention, the filling-level marking is formed integrally with the side wall of the tank container in the form of a profiling which can be produced easily, for example when using a molding or forming process to produce the tank container, such as the injection-molding technique. A post-processing step is thus omitted, e.g. a printing or a thermal transfer of the markings. Optically appealing effects can furthermore be achieved with the aid of the profiling of the side wall and through the guidance of the light.

According to one embodiment of the invention, the profiling comprises at least one surface which is oriented at an angle greater than 30°, in particular greater than 45°, to the plane for the side wall. As a result, the profiling remains easy to see since the refraction of the light differs noticeably from that of the remaining flat surface of the side wall. The profiling in this case can be formed by a groove-type recess for which a part of the surface is embodied essentially at a right angle to the plane for the side wall. The groove-type recess can have a concave curvature, so as to also ensure a directed guidance of the light in the bottom region of the recess.

For an effective production, the tank container can be produced from a plastic material and with the aid of the injection-molding process. A transparent or translucent plastic material is selected for this, at least for the region of the side wall containing the filling-level markings. The side wall in this case can have a thickness ranging from about 2 to 4 mm, wherein the depth or the height of the profiling is in the range of about 0.2 to 1 mm, especially 0.4 to 0.7 mm. However, the profiling can also be embodied so as to project toward the outside instead of as a recess. The profiling can furthermore be embodied on the inside or the outside, wherein an arrangement on the outside is more advantageous for cleaning reasons.

According to a different embodiment of the invention, there is provided a household device used, for example, for the preparation of a hot beverage, which includes the water tank according to the invention. The household device can comprise at least one lighting device which radiates light into a side wall of the tank container for illuminating the filling-level markings. For a better distribution of the light, a light guide can be arranged between the water tank and the lighting device. With the aid of such a light guide, it is possible to purposely illuminate a strip-type section of the tank container provided with the filling-level markings in the form of profiles.

The light can thus be radiated in from above, from below, or from the side, wherein an illumination from below is preferable.

According to another embodiment, the light is radiated in, essentially in the direction of the plane for the side wall containing the filling-level markings, wherein as a result of the profiling of the filling-level markings, the light is emitted at an angle ranging from about 30° to 150°, in particular from about 45° to 135°, to the plane for the side wall, thus making available an appealing optic which is still visible even from a longer distance.

As used herein, “about” means approximately, near or close to a number, that will still achieve effectiveness in the context in which a number is used as would be apparent to a person of ordinary skill in the art.

### BRIEF DESCRIPTION OF THE DRAWINGS

These and other features and advantages of the invention will be further understood from the following detailed description of embodiments with reference to the accompanying drawings, which show in:

FIG. 1A view from the side of a household device according to the invention, provided with a water tank;

FIG. 2A view from the side of the household device according to FIG. 1;

FIG. 3A sectional view through the water tank according to FIG. 2;

FIG. 4A detail view (enlarged) of the profiling on the water tank;

FIG. 5A schematic view of the light guidance at the profiling according to FIG. 4;

FIG. 6A sectional view through a detail of the water tank shown in FIG. 1, in the lower region of the water tank;

FIG. 7A partial sectional view from the side of the water tank in FIG. 1, and

FIG. 8A sectional view of a detail, showing the introduction of the light into the water tank.

### DETAILED DESCRIPTION

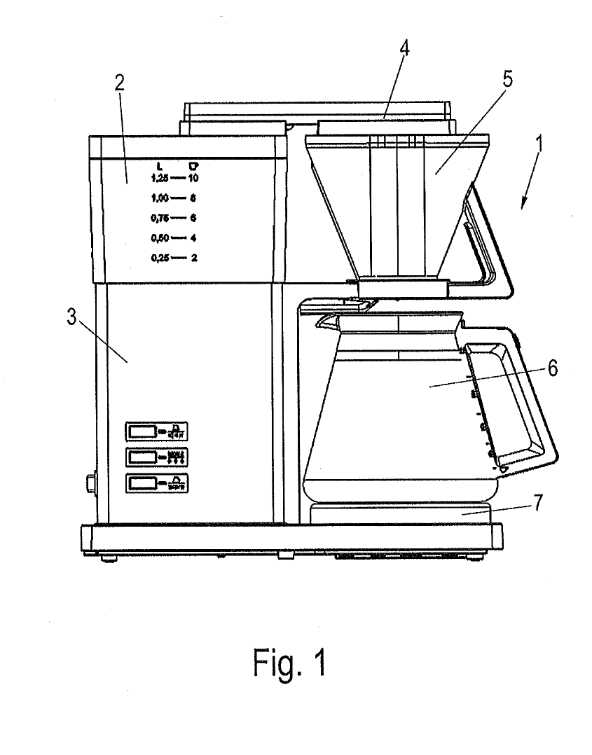

Referring to FIG. 1, there is shown a household device 1 in the form of a coffee machine comprising a tank container 2 into which water is filled and which is connected to a brewing unit 3, by means of which the water is conducted via a line 4 into a filter holder 5. Arranged below the filter holder 5 is a carafe 6 for holding the freshly brewed coffee which is positioned on a warming plate 7.

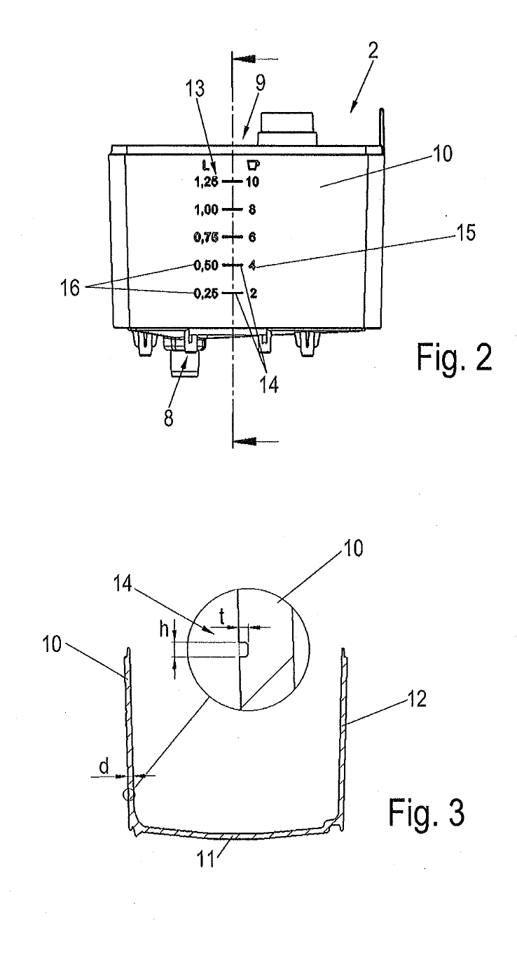

As can be seen from the enlarged representation in FIG. 2, the tank container 2 is provided with filling-level markings 13 on one side wall 10. Fixing projections 8 may be provided in a bottom region of the tank container 2, so that the tank container 2 can be positioned precisely on the brewing unit 3. The tank container 2 may be provided with a filling opening 9 on the top.

The filling-level markings 13 are embodied as profiled sections in the form of groove-type recesses. Simple lines are inserted as filling-level markings 14 while the numbers 15 are arranged adjacent thereto and indicate the brewing amount in the form of the number of cups. The numbers 16, which indicate the amount of water in liters, form additional filling-level markings. The filling-level markings can be embodied on the side wall 10 in a manner that conforms to the customs of the respective country.

FIG. 3 shows that the tank container 2 has a side wall 10, provided with the filling-level markings 13, as well as an opposite-arranged side wall 12 which does not have any filling-level markings, wherein filling-level markings 13 can optionally also be provided on several side walls 10. The side walls 10 and 12 are connected via a bottom section 11.

The tank container 2 is composed of a transparent or translucent plastic and may be produced with an injection-molding technique. The thickness d of the side wall 10 with the filling level markings 13 in this case ranges from about 2 to 4 mm, while the depth of the profiling 14 for the filling-level markings ranges from about 0.2 to 1 mm, in particular about 0.4 to 0.7 mm. The width s of the profiling 14 is also in the range of about 0.2 to 1.4 mm, in particular of about 0.4 to 1 mm.

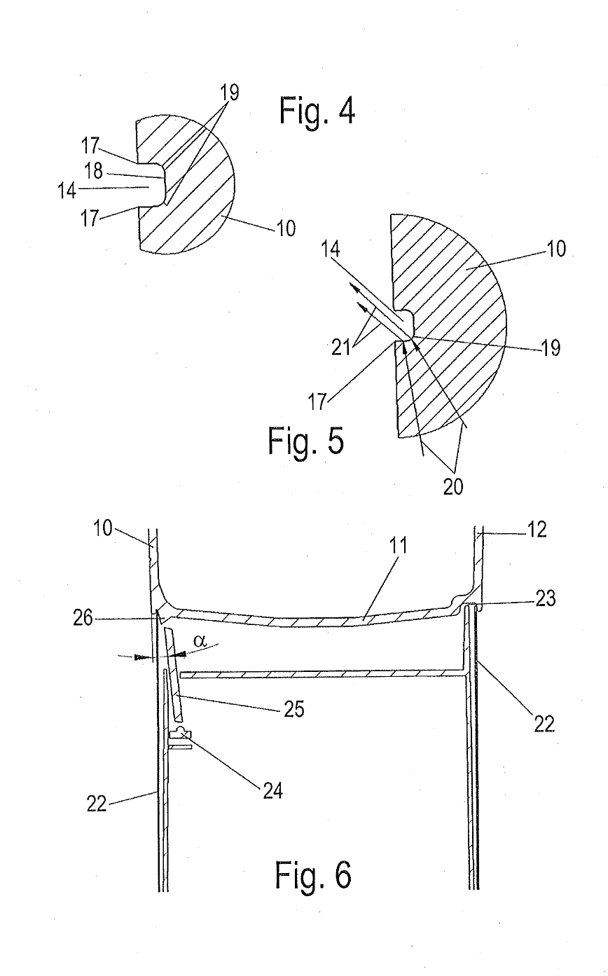

FIG. 4 shows an enlarged sectional view of a profiling 14 for filling-level markings 13. In this example, the profiling 14 is embodied as a groove-type recess that comprises two side walls 17 oriented substantially at a right angle to a surface of the side wall 10. Both side walls 17 are connected via a curved section 19 to a bottom 18 of the profiling.

An edge-type, angular transition is consequently avoided between the side wall 17 and the bottom 18. As shown in FIG. 5, incident light rays 20 which are generated by a light source are refracted in the region of the side wall 17 and the curvature 19 in the area of the boundary surface, meaning the surface of the side wall 17 and the curvature 19. The light rays 21 therefore exit essentially parallel-bundled toward the observer and the observer can see the profiling 14 better since the side wall 17 and the curvature 19 appear to be brighter than the surrounding area.

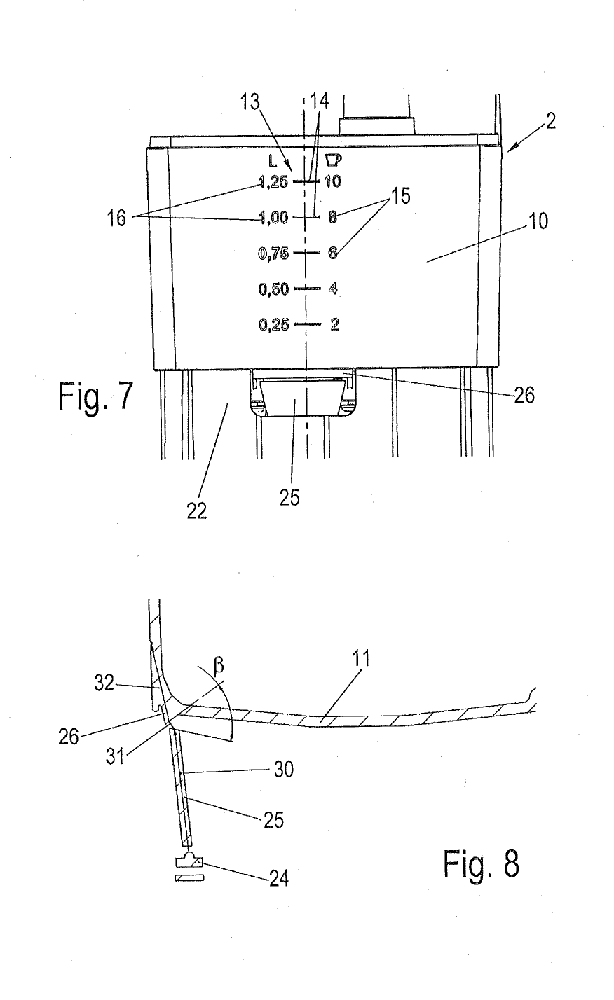

In FIGS. 6 and 7, the bottom 11 of the tank container 2 is shown in an installed position. Provided inside the brewing unit 3 is a lighting device 24 in the form of a light-emitting diode, which radiates light into a plate-shaped light guide 25. The plate-shaped light guide 25 conducts the light to a projection 26 on the bottom 11 of the tank container 2, wherein the light guide 25 is oriented at an angle a to the plane for the side wall 10, so that the incident light is easily radiated toward the outside. The angle a preferably is in the range of about 1° to 20°, in particular about 5° to 15°. As a result of the arrangement of the lighting device 24 and the light guide 25 inside the brewing unit 3, a housing wall 22 of the brewing unit 3 can serve to support the tank container 2, wherein the housing wall 22 engages in a groove-type recess in the bottom 11. Furthermore arranged below the side wall 12 are a recess 23 for accommodating a housing wall 22 and a fixing projection.

As shown in FIG. 7, the light guide 25 is arranged below the filling-level markings 13, so that light is radiated in from below, essentially in the form of striations, via a partial section of the side 10. As a result, the readability and the contrast to the surrounding areas are further increased.

FIG. 8 schematically illustrates the path traveled by the light rays emitted by the lighting device 24. A light ray 30 travels from the lighting device 24 into the light guide 25 and is refracted on the front exit surface of the light guide 25. Upon entering the projection 26 on the underside of the tank container 2, a further refraction takes place and a light ray 32 then travels to the filling-level markings 13. There, the light ray impinges on the profiling and is refracted one more time when it exits from the tank container 2. To make it possible for the light ray coming from the light guide 25 to enter the tank container 2 with the lowest possible loss of intensity, the exit surface on the light guide 25 and the entry surface on the projection 26 are arranged at an angle β which depends on the refractive index for the materials and can range from about 10° to 45°.

For the exemplary embodiment shown herein, the tank container 2 is illuminated only in the area of the filling-level markings 13. Of course, it is also possible to provide a large-surface illumination of the tank container 2 in order to achieve special optical effects. In addition, the light can also be radiated in from the top or from the side, instead of from the bottom, so as to optically emphasize corresponding filling-level markings.

For the exemplary embodiment shown herein, the tank container was used as a component of a coffee machine. Of course, the tank container can also be used for other household devices, in particular used for the beverage preparation.

It will be understood that the above description of the present invention is susceptible to various modifications, changes and adaptations, and the same are intended to be comprehended within the meaning and range of equivalents of the appended claims.

What is claimed is:

1. A water tank for a household device, comprising:
a tank container with a bottom and side walls, at least one of the side walls including filling-level markings that comprise a profiling formed integrally with the at least one side wall.

2. The water tank according to claim 1, wherein the profiling includes at least one surface which is oriented at an angle greater than 30° to a plane of the at least one side wall.

3. The water tank according to claim 1, wherein the profiling is embodied as a groove.

4. The water tank according to claim 3, wherein the the groove has a concave curvature.

5. The water tank according to claim 1, wherein the tank container comprises an injection-molded plastic material.

6. The water tank according to claim 1, wherein the water tank comprises a transparent or a translucent material, at least in a region of the at least one side wall with the filling-level markings.

7. The water tank according to claim 1, wherein the tank container has a side wall thickness of between about 2 mm and about 4 mm.

8. The water tank according to claim 1, wherein the profiling has one of a depth or height in a range of about 0.2 to 1 mm.

9. A household device forming a combination with the water tank according to claim 1.

10. The household device according to claim 9, further comprising at least one lighting device which radiates light into the at least one side wall of the tank container.

11. The household device according to claim 9, further comprising a light guide arranged between the water tank and the lighting device.

12. The household device according to claim 11, wherein the light guide is essentially positioned below the filling-level marking and ensures that incident light is radiated into a partial section of the side wall.

13. The household device according to claim 10, wherein the light guide is arranged so that light is radiated in essentially in a direction of the plane for the at least one side wall provided with the filling-level markings.

14. The household device according to claim 10, wherein the light guide is arranged so that light radiated into the side wall in a region of the profiling for the filling-level marking is emitted at an angle between 30° and 150° relative to the plane for the side wall.

15. The household device according to claim 9, wherein the household device comprises a coffee machine.
